(19) United States
(12) Patent Application Publication
(10) Pub. No.: US 2017/0306878 A1
(43) Pub. Date: Oct. 26, 2017

(54) ENGINE WITH DIRECT INJECTION AND PORT FUEL INJECTION ADJUSTMENT BASED UPON ENGINE OIL PARAMETERS

(71) Applicant: GM Global Technology Operations LLC, Detroit, MI (US)

(72) Inventors: Mark R. CLAYWELL, Birmingham, MI (US); Maqsood Rizwan ALI KHAN, Rochester Hills, MI (US); Bryan K. PRYOR, Waterford, MI (US)

(21) Appl. No.: 15/133,955

(22) Filed: Apr. 20, 2016

(51) Int. Cl. F02D 41/30; F02D 41/14; F02D 41/00

(52) U.S. Cl. CPC F02D 41/3094; F02D 41/0097; F02D 41/14

(57) ABSTRACT

An internal combustion engine includes an engine structure defining a cylinder having an intake port and an exhaust port. A piston is disposed in the cylinder and is drivingly connected to a crankshaft. A direct injection system injects fuel directly into the cylinder. A port fuel injection system injects fuel into the intake port. An oil temperature sensor and an engine speed sensor are in communication with a controller that controls the direct injection system and the port fuel injection system based on measured oil temperature and engine speed. In particular, the controller employs a control algorithm that alters the direct injection and port fuel injection split based on the measured oil temperature and engine speed. The maximum direct injection pressure reduction is limited by a maximum allowable port fuel injection duty cycle as determined by the controller.

### FIELD

The present disclosure relates to internal combustion engines and more particularly to an engine with direct injection and port fuel injection adjustment based upon engine oil parameters.

### BACKGROUND AND SUMMARY

This section provides background information related to the present disclosure which is not necessarily prior art.

Internal combustion engines are often provided with fuel injectors that inject fuel directly into the combustion cylinders. The fuel injectors are supplied with fuel by a direct injection high pressure pump which can be driven by a cam mechanism. The cam mechanism can experience high stress/load at the cam-follower interface. At high engine speeds and high engine oil temperatures, a lubricating oil film thickness on the cam follower interface and on the cam bearings can be reduced which leads to premature wear.

Accordingly, it is desirable to prolong the direct injection high pressure fuel pump life by reducing the cam stress/load at the cam-follower interface. The present disclosure provides an internal combustion engine, including an engine structure defining a cylinder having an intake port and an exhaust port. A piston is disposed in the cylinder and is drivingly connected to a crankshaft. A direct injection system injects fuel directly into the cylinder. A port fuel injection system injects fuel into the intake port. An oil temperature sensor and an engine speed sensor are in communication with a controller that controls the direct injection system and the port fuel injection system based on measured oil temperature and engine speed. In particular, the controller employs a control algorithm that alters the direct injection and port fuel injection split based on the measured oil temperature and engine speed. The maximum direct injection pressure reduction is limited by a maximum allowable port fuel injection duty cycle as determined by the controller.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of an internal combustion engine having direct injection and port fuel injection according to the principles of the present disclosure;

FIG. 2 is a schematic illustration of a cam drive system for a direct injection pump according to the principles of the present disclosure;

FIG. 3 is a graph of the camshaft bearing oil film thickness verses oil temperature; and

FIG. 4 is an exemplary look-up table plot of the direct injection limited pressure verses engine speed.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

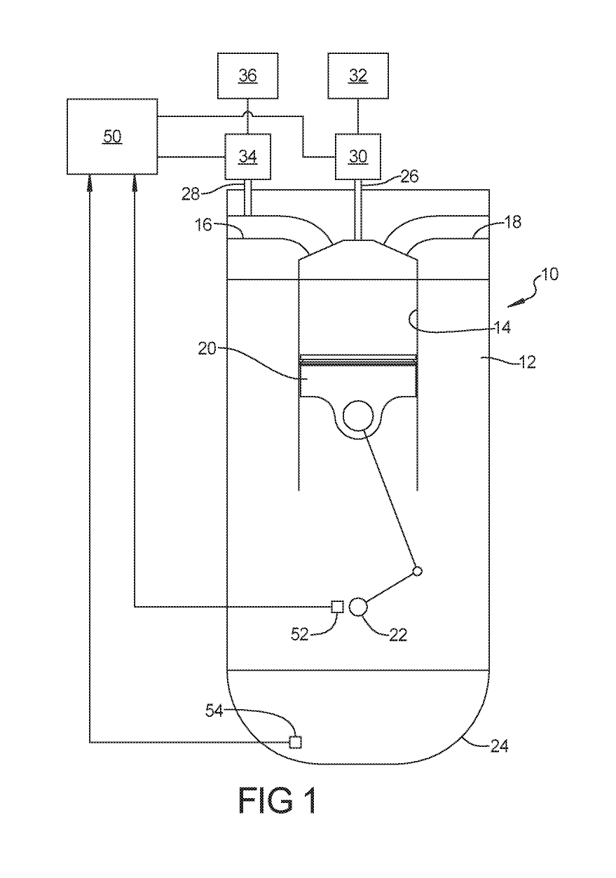

With reference to FIG. 1, an internal combustion engine 10 is shown including an engine structure 12 defining a cylinder 14. An intake port 16 and an exhaust port 18 each communicate with the cylinder 14. A piston 20 is disposed within the cylinder and is connected to a crankshaft 22. The engine 10 can include an oil pan 24 in which the lubrication oil collects. The engine 10 includes a direct injection fuel injector 26 that injects fuel directly into the cylinder 14 and a port fuel injection injector 28 that injects fuel into the intake port 16. The direct injection fuel injector 26 includes an actuator 30 and is in communication with a direct injection fuel pump 32. The port fuel injection injector 28 includes an actuator 34 and is in communication with a port fuel injection pump 36.

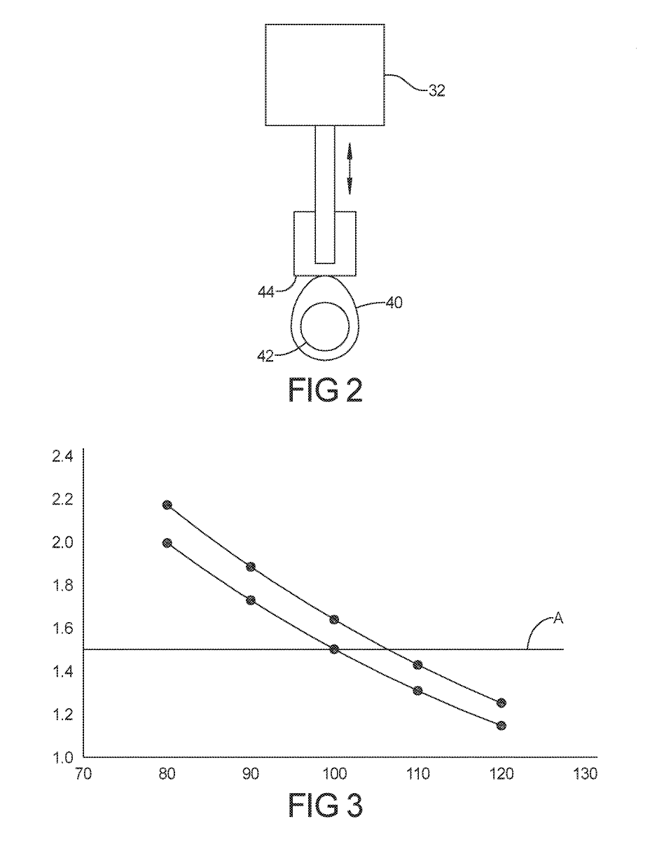

With reference to FIG. 2, the direct injection fuel pump 32 is driven by a cam lobe 40 of a camshaft 42 that engages a cam follower 44 that drives the direct injection fuel pump 32 in a reciprocating manner. The camshaft 42 includes bearing surfaces on which an oil film is formed. As the oil temperature increases, an oil film thickness can decrease. Continuous operation of the direct injection fuel pump 32 under high temperature and high engine speed and load conditions can stress the cam-follower interface that can reduce the life of the direct injection pump 36.

Internal combustion engine 10 includes a controller 50 that controls operation of the actuator 30 of the direct injection fuel injector 26 and the actuator 34 of the port fuel injection injector 28. The internal combustion engine 10 also includes an engine speed sensor 52 and an oil temperature sensor 54 to provide signals to the controller 50. As the engine speed and/or oil temperature rise to predetermined threshold levels, the load on the direct injection fuel pump 32 is decreased by the controller 50 which increases the amount of fuel introduced by the port fuel injector 28 in order to offset the reduced fuel injection by the director fuel injector 26.

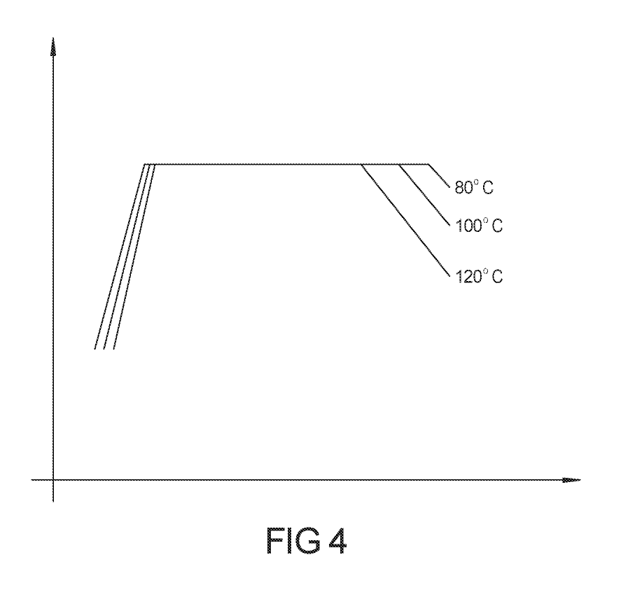

In operation, the controller 50 receives inputs relating to oil parameters that can affect the oil viscosity. According to one preferred example, the controller receives the engine oil temperature and engine speed from the oil temperature sensor 54 and the engine speed sensor 52. According to an alternative embodiment, the sensor 54 can be another device that senses oil parameters that can be used to infer oil quality such as an oil viscosity sensor. As shown in FIG. 3, as the oil temperature (along the X-axis) exceeds a predetermined threshold level indicative of a bearing oil film thickness (along the Y-axis) that is below a threshold thickness (represented by line A), the controller 50 can determine a reduced or limited direct injection pressure from a look-up control map (see the example look-up map of FIG. 4 which is a plot of the direct injection limited pressure (MPa) on the vertical axis verse engine speed (RPM) on the horizontal axis for different oil temperatures) or an algorithm and compute a port fuel injection amount to offset the reduced or limited direct injection pressure. The direct fuel injection amount and port fuel injection amount can each be increased or decreased based upon a duty cycle of the respective actuators 30, 34. In order to protect the direct injection high-pressure pump 32 from premature wear, the controller 50 increases the port fuel injection amount based on measured oil temperature and engine speed. The maximum direct injection pressure reduction is limited by the maximum allowable port fuel injection duty cycle. To the extent that the port fuel injection amount can be increased, the direct fuel injection amount can be decreased by an off-setting amount. It should be understood that other means of measuring or inferring oil viscosity (such as the above mentioned oil viscosity sensor) can be utilized for altering the direct injection and port fuel injection split.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An internal combustion engine, comprising:
an engine structure defining a cylinder having an intake port and an exhaust port;
a piston disposed in the cylinder;
a crankshaft drivingly connected to the piston;
a direct injection system for injecting fuel directly into the cylinder;
a port fuel injection system for injecting fuel into the intake port;
an oil temperature sensor;
an engine speed sensor; and
a controller that controls the direct injection system and the port fuel injection system based on at least one of a measured oil temperature and a measured engine speed, wherein the controller employs a control algorithm that alters a direct injection and port fuel injection split based on the measured oil temperature and the measured engine speed, wherein the controller determines a maximum direct injection pressure reduction based upon a maximum allowable port fuel injection duty cycle, wherein when the controller determines that all of an available port fuel injection duty cycle has been utilized and a direct injection pressure is at a maximum, then the controller limits a total fuel flow to the cylinder.

2-4. (canceled)

5. An internal combustion engine, comprising:
an engine structure defining a cylinder having an intake port and an exhaust port;
a piston disposed in the cylinder;
a crankshaft drivingly connected to the piston;
a direct injection system for injecting fuel directly into the cylinder;
a port fuel injection system for injecting fuel into the intake port;
means for determining parameters relating to oil viscosity;
an engine speed sensor; and
a controller that controls the direct injection system and the port fuel injection system based on the parameters relating to oil viscosity and a measured engine speed, wherein the controller employs a control algorithm that alters a direct injection and port fuel injection split based on the parameters relating to oil viscosity and the measured engine speed, wherein the controller determines a maximum direct injection pressure reduction based upon a maximum allowable port fuel injection duty cycle, wherein when the controller determines that all of an available port fuel injection duty cycle has been utilized and a direct injection pressure is at a maximum, then the controller limits a total fuel flow to the cylinder.

6-8. (canceled)
